(19) United States
(12) Patent Application Publication
(10) Pub. No.: US 2017/0367302 A1
(43) Pub. Date: Dec. 28, 2017

(54) Animal Control Rod

(71) Applicant: Bryan Caudill, North Huntingdon, PA (US)

(72) Inventor: Bryan Caudill, North Huntingdon, PA (US)

(21) Appl. No.: 15/195,875

(22) Filed: Jun. 28, 2016

(51) Int. Cl. A01K 27/00; A01K 15/02

(52) U.S. Cl. CPC A01K 27/003; A01K 15/02

(57) ABSTRACT

An animal restraint apparatus for positioning an animal rearward of user during walks. The apparatus is a combination of a rigid rod and flexible lead-line. The apparatus rod includes a protective sleeve pad for being grasped in the elbow cradle of one arm and a rod handle that is grasped with the opposite arm's hand. The rod is oriented rearward of the user in a substantially horizontal plane. A shoulder-strap or holster configuration may be employed to assist in holding and maintaining the animal restraint rod in its desired position.

### FIELD OF INVENTION

This invention relates to animal leashes, such as those that are provided for walking dogs and the like. Dog leashes and animal control poles are well known in the art and have been provided heretofore in a variety of different forms to accomplish various desired purposes, characterized by the provision of an arrangement that provides an attachment of animal.

### BACKGROUND OF THE INVENTION

Many different forms of leash apparatus and related devices have been used in the past to assist dog handlers in training dogs. Typically, dog leashes and the like comprise a fastener hook member and a hand grip member mounted on opposite terminal ends of a leash strap or chain. The prior art leashes are commonly formed of chain-link material or flexible but inelastic strap. The inelastic strap maybe made of cords woven or otherwise formed of synthetic plastic material.

When being walked dogs generally move ahead of the walker and sometimes pull on the leash in a manner that makes it difficult for the handler to maintain control. In order to maintain the dog at the handler's side, he has to shorten up the leash and in or extend his hand and arm behind his back in order to maintain the dog by his side. This is obviously an awkward and inconvenient manner of control and does not foster teamwork and harmony between the walker and dog.

In teaching a dog to heel, the dog usually must be physically grasped by hand and positioned relative to the handler, at least during the early part of the training session, so that it learns the expected positional relationship to the walker required in response to the heel command. A flexible leash or chain-link makes such training difficult.

Another dog restraint known in the art is a long rigid pole. Typically, these are employed by animal control officers or policeman. The usual apparatus is some form of long rigid pole with a handle (e.g. loop) at one end of the pole and a fattener hook at the other end or a tube through which a cable passes and forms a loop on one end that it tightened about the dog's neck. These are necessary when control of the dog is a paramount, such as when catching stray dogs. Both employ a rigid elongated pole member to keep the dog's head far away from the handler. These devices are harsh and prevent a dog from comfortably moving its head in any direction, and also limits the dog itself from moving independently from the handler in any direction. They can be very irritating for a dog and a dog may become hostile and aggressive.

While control poles provide absolute control the dog, these devices are not suitable for training most dogs as they do not foster the relationship the owner usually desires with the dog because of the dominating nature of the control pole.

It is desirable that a dog and his master form a team. There is a psychological as well as physical relationship. Many things comprise parts of the relationship: such as sound, sight, taste, smell, size, age and direct feel and touch between the collar and leash. A master best communicates with a dog by controlling the dog by using a leash or pole attached to a dog collar. Safety for both dog and master dictates that a dog or animal is kept at arms-length to prevent unexpected, unwanted or unnecessary physical contact between the two. A chain-link or flexible leash does not permit a trainer to have adequate control over a dog. A leash must be grasped close to the dog to better control the dog yet still is not as effective as a long rigid pole.

Neither a chain-link or flexible leash strap are suitable for dog training. A dog needs to be kept from wandering and adequately restrained. The dog must be firmly guided but in a less harsh fashion than a rigid control pole to encourage obedience and build trust.

As a descendant of a wolf it is believed by many professional dog trainers that domestic dog behavior shares many attributes of wild wolves. In particular, it is believed that each wolf pack has a dominant alpha wolf that leads the pack. Accordingly, a handler during walks should be positioned forward with the dog trailing behind. Such positioning is more conducive to success by the walker in controlling the dog.

There is thus a need for an animal training device that allows a handler to exert more direct physical control over the dog yet has some of the benefits of a flexible leash.

There is thus a need for a dog control device that allows the dog walker to conveniently position the dog at behind and at the simultaneously encourages the dog to stay in position and not move ahead during the walk.

### SUMMARY OF THE INVENTION

Toward this end, the dog walking device of this present invention provides an animal control apparatus in the form of a substantially rigid rod having an integral leash forming a lead-line extending beyond an end of the rigid rod. A user handle arrangement at the opposite proximal end of the rod, and attachment means at an end of the lead-line for fastening to the dog.

One object of this invention is to provide a rigid animal control rod of specified length having an integral leash forming a lead-line, the orientation of the lead-line may be controlled by the opposite distal end of the rigid control rod, with the rigid control rod the user restricts the movement of the animal attached at an end of the lead-line.

Another object of this invention is the provision of an animal walking apparatus which may inherently assist in the dog learning desirable leash walking behaviors. The present invention includes a rigid control rod for more direct control while simultaneously having a lead-line allowing for a less rigid strong-arm relationship with the dog being trained.

Still another object of the present invention is to provide an apparatus of the type described that can be used to encourage a dog to walk behind and to the side of a master.

An animal control assembly comprising a combination of a rod having a lead-line at the distal end and handle means at the opposite proximal end, a shoulder strap connected to the rod nearer the proximal end, and a protective pad fixed to the rigid rod between the rod handle means and where the shoulder strap is connected, so the user may comfortably and securely maintain the dog in a position behind and to the side.

It is therefore an object of the present invention to provide a dog training and control apparatus that can be used to control both large and small dogs as they are trained to walk alongside their owner.

Another object of the present invention is to provide an apparatus that allows a user to take a proactive approach, not just in reacting and avoiding dog misbehavior by simply responding to it. An apparatus is needed that permits a user to better position and steer an animal than a common leash.

A still further object of the present invention is to provide an apparatus of the type described which enables an owner to proactively control the position, not just responding to undesirable dog behavior, the dog may be directly positioned by the user to walk behind its user.

The present invention rigid animal control rod includes a lead-line which may be used to teach and or prohibit puppies as well as full grown dogs from certain behavior. The present invention may make walking a dog much more enjoyable and easy due to added control in three-dimensions while still providing ample freedom of movement. The present invention rigid control rod may help the user better prevent the dog from jumping or grabbing the present invention out of the user's hands. Furthermore, the rigid nature of the present invention prevents tangling within the user's legs or within the dog's legs.

A presently preferred embodiment of the present invention animal control assembly includes an rod having a lead-line at one distal end and handle means at the opposite proximal end, a holster means for attaching the animal control rod to a user's belt, the holster is connected to the animal rod nearer the proximal end, and a protective pad fixed to the rigid rod between the rod handle means and distal end, and where the protective pad, holster means and handle means are configured in position so the user may comfortably and securely maintain the dog in a position behind and to the side.

An important advantage of the present invention is that it provides an apparatus that allows the owner to both position the dog behind him but allows the dog some freedom to stray a short distance away.

In accordance with the present invention, a dog walking device is provided, which substantially eliminates or reduces disadvantages and problems associated with previous systems and methods. The present invention provides a dog training device capable of conveying specific nonverbal commands from the user to the dog in an efficient manner. In one embodiment, the pet restraint device of the present invention utilizes a rigid, elongated member having a proximal end and a distal end; the elongated member is hollow, a leash is inserted into a side opening located nearby the proximal end of the elongated member and through the distal end of the elongated member, the forwardly portion of the leash strap extending outward beyond the rod distal end constitutes the lead-line, the lead-line is connected to a clasping means for releasably securing an animal to the animal control rod and a handle means attached to the elongated member for being grasped by the user. More specifically, the lead-line may be attached to any conventional dog collar via a snap, hook, clip, or other suitable clasping means. The more rigid property of the pet training/walking device of the present invention allows the user to clearly convey his or her intentions as to the animal's behavior through movement of the elongated.

The foregoing and other objects and advantages of the present invention will appear from the following detailed description, taken in connection with the accompanying drawings of a preferred embodiment.

### BRIEF DESCRIPTION OF THE DRAWINGS

For a more complete understanding of the present invention and the advantages thereof, reference is now made to the following description taken in conjunction with the accompanying drawings in which like reference numbers indicate like features, wherein:

FIG. 1 illustrates a present invention pictorial representation of a preferred method of walking a dog,

FIG. 2 illustrates a first preferred embodiment of the animal control assembly present invention,

FIG. 3 illustrates a second preferred embodiment of the animal control assembly present invention.

### DESCRIPTION OF THE PREFERRED EMBODIMENTS

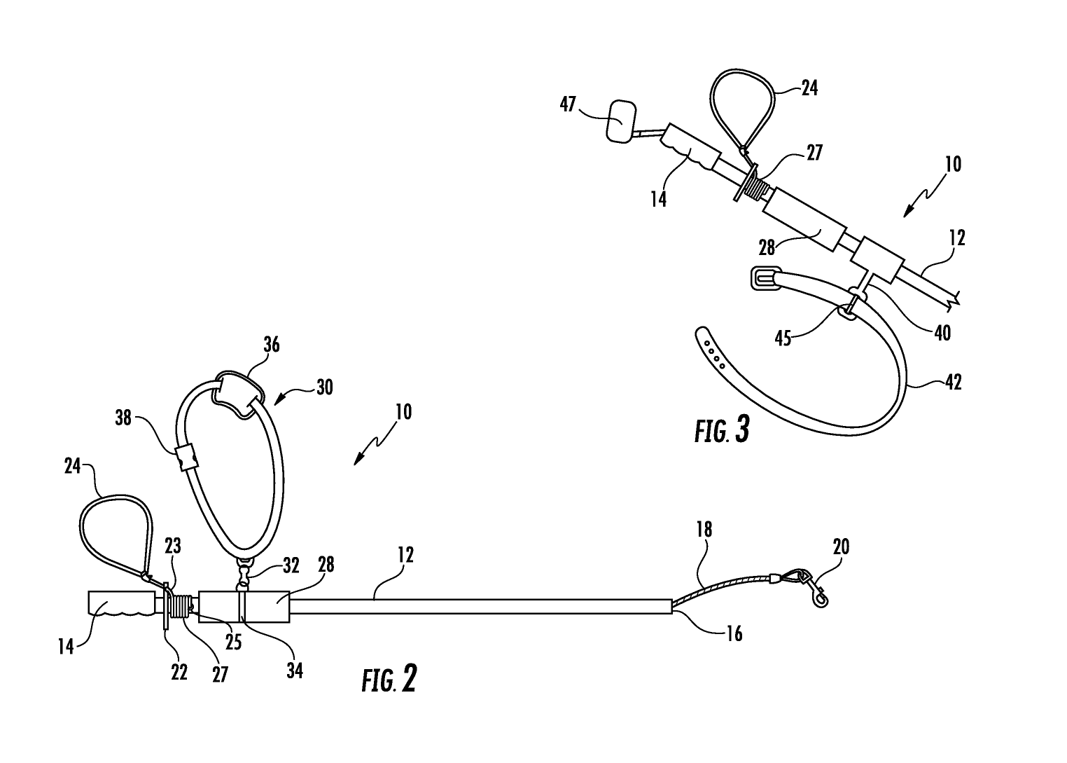

FIG. 2 illustrates a shoulder strap 30 connected to an animal rigid control rod 10 which embodies features of the present invention. As seen, a preferably rigid tube 12 is provided in the form of a desired length of suitable material such as, in the case of the illustrated example, conventional thick-walled PVC pipe. The tube 12 illustrated herein may be within the range of 24-60 inches in length and having an outside diameter between ½-2 inches. A leash is inserted into and coupled to the tube 12. A lead-line 18 portion of the leash extends beyond the outlet opening 16 of the tube, another portion of the leash (not visible) extends within a long portion of the tube 12 from the outlet opening 16 to a side opening 25. As seen in FIG. 2 most of the remaining portion of the leash is wrapped 27 about the tube 12 and the leash hand loop is employed as a wrist band 24 by the user of the animal control rod.

One end portion of the tube, hereinafter referred to as the proximal end of the tube, preferably mounts a comfortable hand grip 14 for convenient grasping by a user while walking/training a dog. The tube 12 at its opposite distal end has an opening 16. The tube has a side opening 25 near the hand grip. A leash may be inserted in the side opening 25 and fed through the tube toward the outlet opening 16. The opening 16 is constructed in size so as to permit a clasping means 20 to be properly inserted therein so as to permit the clasping means 20 to travel forward and backward in the tube 12. A user may feed the leash through the tube 12 as much as desired to achieve a desired lead-line 18 length. The length of the lead-line 18 is increased by continually pushing the leash through the outlet opening 16 until it extends beyond the opening 16 a desired amount. A user may then wind the remaining length of leash, that has not been pushed into the side opening 25, about tube 12 as shown at 27 in FIG. 2. Once a user has nearly completely wound the reaming leash portion about the tube 12, but for the wrist band 24, the leash is secured to the animal control rod by pressing the leash strap into a notch 23 formed on the outer circumference of disc guard 22.

The leash strap may be made of cords woven or otherwise formed of synthetic plastic material, nylon or other well-known materials used for making leashes. Attached at an end of the lead-line 18 is a clasping means 20, including but not limited to a spring-hook, for securing the animal control rod to a dog collar.

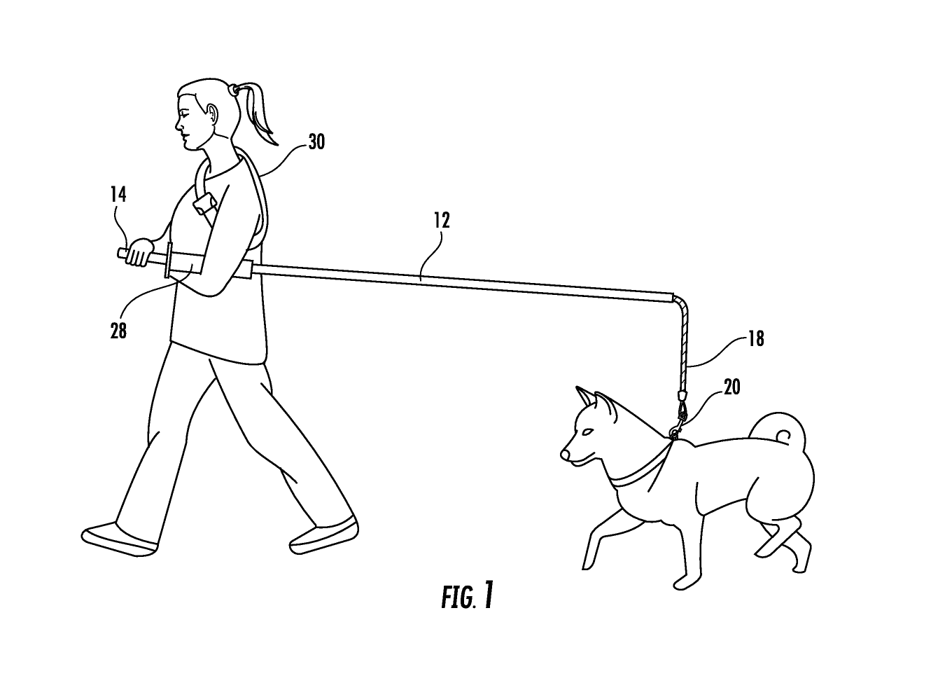

The disc guard 22 surrounds the tube 12 nearby the hand grip 14. A protective sleeve pad 28, is cylindrical and has a central opening therein for receiving the tube 12. The protective sleeve pad 28 surrounds the tube 12 at a position closer to the handle means 14. The protective sleeve pad 28 provides cushioning for the user while walking a dog as demonstrated in FIG. 1. Otherwise extended use of the animal control rod, as it is employed in FIG. 1, may cause chafing or irritation. The protective sleeve 28 may be formed of woven or knitted nylon, or similar smooth fabric material, a polyurethane foam, cashmere wool or other soft, non-abrading material.

The present animal control rod 10 can be used to train/walk dogs and the like, the dog can be attached to the lead-line 18; whereby the dog can be held at a distance from the user. The rigidity of the tube 12 enables the user to substantially directly steer the dog toward and away from the user, side-to-side, as well as push up-and-down. In this way, the animal control rod 10 can be used as a training device to teach puppies and/or full grown dogs not to jump or otherwise misbehave during walking and/or training. The animal control rod 10 of the present invention permits an owner to proactively control the position of the dog.

With the present invention a dog may be directly positioned by the user to walk behind and to the side of its user, see FIG. 1. As shown in FIG. 1, a user cradles the protective sleeve 28 in the left elbow of the user and under the left arm. With the protective sleeve 28 cradled in the left elbow the user grasps the handle means 14 with the right hand. With a user's hand situated this way the animal control rod may be oriented substantially horizontally and in a rearward direction. The user thereby effectively takes the lead while walking and situates the dog in the desired rear position. A user may prefer to reach across their body and with their free left hand grasp their right forearm (not shown). Optionally users may situate their arms in a similar reverse fashion so the dog is placed in a rearward position on the right side of a user's body.

In accordance with an aspect of the invention, the leash hand loop is configured to be employed as a safety wrist strap 24. The leash hand loop 24 is positioned near the animal control rod near the handle 14 so as to be worn around a wrist of the user during use.

The present dog animal control rod 10 may or may not have means for attachment to a user's waist or shoulder. In an animal control assembly, a means for attachment to a user's waist or shoulder provides additional assurance to the wrist band 24 that a dog will not break free while walking or exercising with a dog fixed to the animal control rod of the present invention.

In FIG. 2 a shoulder strap 30 is connected to the rigid tube 12. The should strap 30 is coupled to the tube 12 by a quick connection means 32. The quick disconnect means 32 may be directly coupled to the tube 12 or may be coupled to the tube 12 indirectly via a strap 34 encircling the protective sleeve pad 28. The shoulder-strap 30 has a neck pad 36 that is positioned adjacent a user's neck on the side opposite the animal control rod as illustrated in FIG. 1. The shoulder-strap includes quick disconnect means 38 for allowing a user to mount and dismount the should-strap quickly. Preferably, the disconnect means 38 utilizes a quick-release connector comprising a connector (female portion) and a pronged connector (male portion). The quick-connect/disconnect feature allows for quick handling and response to any emergency. The shoulder strap 30 may be made of various fabrics, plastics, cloth, or other flexible materials, a preferred version may use woven nylon strap.

A second preferred embodiment is illustrated in FIG. 3 wherein the rigid control rod 10 is similar to the first embodiment illustrated in FIG. 2, but for the method of attaching the rigid control rod 10 to the user is different. In the second preferred embodiment, the alternative manner of attachment includes a holster means 40 for attaching the animal control rod 10 (partially shown) to a user's waist belt 42. The holster means 40 is directly connected to the rigid tube 12 at a location closer to the handle means than the distal end (not shown in FIG. 3). Similarly, a protective pad sleeve 28 is fixed to the rigid rod between the handle means 14 and where the holster means 40 is connected to the tube 12. The holster means 40, protective pad sleeve 28 and handle means 14 allow the user to comfortably and securely maintain the dog in a position behind and to the side of the user while walking the dog according to the method shown in FIG. 1. As shown in FIG. 3 a belt loop 45 is shown as a means for securing the holster means 40 onto the waist belt 42. As an alternative to the belt loop 45 a hook, clip, snap, or other suitable attachment mechanism may be employed for attachment to the user's waist belt.

In some preferred embodiments, the rigid tube 12 may be formed from plastic tubing such as, for example but not limited to polyvinylchloride (PVC), including ½″ or ¾″ PVC pipe. Alternatively, the rigid tube 12 could be formed from a strong, lightweight metal material such as, for example but not limited to, extruded aluminum tubing. The device of the present invention can be made in any necessary and useful size, strength and flexibility for the service required from a small dog to a large dog.

Optionally, the embodiment illustrated in FIG. 2 may include means (not shown) for adjusting the shoulder strap into fixed positions relative to a user's arms to accommodate different sized users and/or preferences in positioning the animal control rod. Such adjusting means would allow the user to select and control the location of the animal control rod relative to the user, based on personal preference, walking path terrain, or different sized dogs. Means for adjusting the positions could include such elements as hooks, adjust buckles, ties, clasps or other well-known apparatus and methods in the art.

In a still further preferred embodiment, it is contemplated that a simple rearview 47 mirror as well-known in the art to be attached to motorcycles handlebars and bicycle handlebars may in a like manner be attached near the handle 14 of the present invention. The rearview mirror serves the purpose of allowing a trainer/walker to observe the dog without having to turn their head around. See U.S. Pat. No. 564,454 (Ryan), U.S. Pat. No. 3,995,945 (Addicks) and U.S. Pat. No. 4,326,774 (Beigl) which are all incorporated herein by reference in its entirety. Also see U.S. Patent Application Publication No. 2016/0070084 (Owyang) which is incorporated herein by reference in its entirety.

While certain novel features of this invention have been shown and described, it is not intended to be limited to the details above, since it will be understood that various omissions, modifications, substitutions and changes in the forms and details of the coating can be made by those skilled in the art without departing in any way from the spirit of the present invention.

The invention claimed is:

1. An animal control rod comprising:
an elongated member having a proximal end and distal end, wherein the proximal end has a handle means;
a lead-line is connected to said elongated member, said lead-line is attached to a clasping means for attaching to an animal collar, and
a protective pad fixed to said elongated member between said handle means and said distal end so a user may comfortably and securely maintain an animal in a position behind and to the side of said user.

2. An animal control rod according to claim 1, wherein said elongated member is hollow and said lead-line is formed by a first end of a leash,
said leash having a second opposite end, said second end connected to said proximal end of said elongated member.

3. An animal control rod according to claim 1, wherein said leash is connected to said proximal end by being wound about said elongated member and inserted in a notch on a disc guard.

4. An animal control rod according to claim 1, wherein said elongated member is adapted in strength, size and flexibility for controlling a large dog.

5. An animal control rod according to claim 1, wherein said elongated member is adapted in strength, size and flexibility for controlling a small dog.

6. An animal control assembly comprising:
an elongated member having a proximal end and distal end, wherein said proximal end has a handle means,
a lead-line is connected to said elongated member, said lead-line has is connected to a clasping means used for attachment to an animal collar, and
a protective pad fixed to said elongated member between said handle means and said distal end so a user may comfortably and securely maintain an animal in a position behind and to the side of said user.

7. An animal control assembly according to claim 6, further comprising:
a shoulder strap wherein said shoulder strap is connected to said elongated member at a position closer to the proximal end.

8. An animal control assembly according to claim 7, wherein said shoulder strap further comprises adjusting means for varying the position of said animal control rod on the user.

9. An animal control assembly according to claim 6, wherein said shoulder strap further comprises a neck pad

10. An animal control assembly according to claim 6 further comprising:
a holster means wherein said holster means is connected to said elongated member at a position closer to the proximal end.

11. An animal control assembly according to claim 10, further comprises:
a wrist strap connected to said elongated member.

12. An animal control assembly according to claim 10, wherein said holster means further comprises
means for securing said holster means to a waist belt.

13. An animal control assembly according to claim 10, further comprises:
a rearview mirror.
